(19) United States
(12) Patent Application Publication
(10) Pub. No.: US 2014/0320901 A1
(43) Pub. Date: Oct. 30, 2014

(54) INFORMATION PROCESSING DEVICE, PRINT SETTING DISPLAY METHOD, AND RECORDING MEDIIUM STORING PRINT SETTING DISPLAY PROGRAM

(71) Applicants: Ken MITSUI, Kanagawa (JP); Naoyuki URATA, Kanagawa (JP); Kanna IINUMA, Kanagawa (JP); Kenichi FUJIOKA, Kanagawa (JP); Teruyoshi YAMAMOTO, Tokyo (JP)

(72) Inventors: Ken MITSUI, Kanagawa (JP); Naoyuki URATA, Kanagawa (JP); Kanna IINUMA, Kanagawa (JP); Kenichi FUJIOKA, Kanagawa (JP); Teruyoshi YAMAMOTO, Tokyo (JP)

(21) Appl. No.: 14/245,315

(22) Filed: Apr. 4, 2014

(30) Foreign Application Priority Data
Apr. 30, 2013 (JP) 2013-095970

(51) Int. Cl. G06F 3/12

(52) U.S. Cl. CPC G06F 3/1255; G06F 3/1288
USPC 358/1.15

(57) ABSTRACT

An information processing device, a print setting display method, and a print setting display program stored in a recording medium are provided. Each of the information processing device, the print setting display method, and the print setting display program accepts instructions for print settings that include special page print settings, generates a print setting list including the special page print settings, generates a preview image that reflects finished quality of printing based on the print settings, and displays the preview image on a display based on the print setting list and the print settings.

### CROSS-REFERENCE TO RELATED APPLICATION

This patent application is based on and claims priority pursuant to 35 U.S.C. §119(a) to Japanese Patent Application No. 2013-095970, filed on Apr. 30, 2013, in the Japan Patent Office, the entire disclosure of which is hereby incorporated by reference herein.

### BACKGROUND

1. Technical Field

Example embodiments of the present invention generally relate to an information processing device, a print setting display method, and a non-transitory recording medium storing a print setting display program.

2. Background Art

In the print on demand (POD) market, where electronic data is printed for customers by using digital printers, there are various needs for printing. For example, in some printing, some of the pages need to be a different kind of paper, or an index paper needs to be inserted at some midpoint of the pages. In order to achieve such printing, most printer drivers of client PCs (personal computers) are provided with both the capability to print normal pages with general print settings and the capability to print a particular page using different print settings. (Herein, such print settings for particular pages are referred to as special page settings, and such particular pages are referred to as special pages.) These printer drivers display special page settings on a user interface (UI) when several sets of special page settings are introduced, and it is common to display a list of such special page settings in text format.

### SUMMARY

Embodiments of the present invention described herein provide an improved information processing device, a print setting display method, and a print setting display program stored in a recording medium. Each of the information processing device, the print setting display method, and the print setting display program accepts instructions for print settings that include special page print settings, generates a print setting list including the special page print settings, generates a preview image that reflects finished quality of printing based on the print settings, and displays the preview image on a display based on the print setting list and the print settings.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 illustrates a configuration of a printing system provided with information processing devices, and a printer or the like connected to the information processing devices, according to an example embodiment of the present invention.

FIG. 2 illustrates an example of printed materials including insertion pages and exceptional pages, which are produced by the printing system of FIG. 1.

FIG. 3 depicts the details of print settings for special pages, which are used for generating the printed materials of FIG. 2.

FIG. 4 depicts a display screen of a print setting list (excluding job settings) and preview images that correspond to the print setting list, according to an example embodiment of the present invention.

FIG. 5 depicts a display screen of a print setting list (including job settings) and preview images that correspond to the print setting list, according to an example embodiment of the present invention.

FIG. 6 depicts a display screen of another print setting list (including job settings) and preview images that correspond to the print setting list, according to an example embodiment of the present invention.

FIG. 7 is a functional block diagram of a client PC, according to an example embodiment of the present invention.

FIG. 8 is a functional block diagram of a DFE (digital front end) controller according to an embodiment of the present invention.

FIG. 9 is a flowchart of an operating procedure for configuring special page settings and performing printing, according to an example embodiment of the present invention.

FIGS. 10A and 10B are flowcharts of the processes performed by a client PC and a DFE controller, according to an example embodiment of the present invention.

FIG. 11 depicts an example (extract) of a job ticket according to an example embodiment of the present invention.

FIG. 12 is a flowchart of raster image processing according to an example embodiment of the present invention.

FIG. 13 is a hardware block diagram illustrating a structure of a client PC according to an example embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits (ASICs), field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

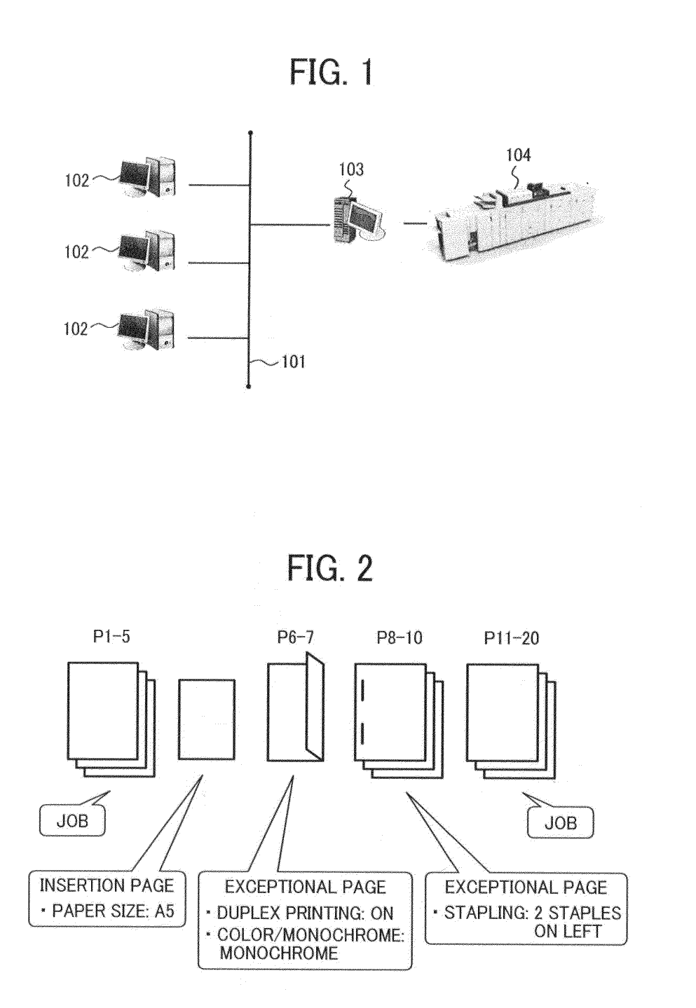

Example embodiments of the present invention are described below with reference to the drawings. FIG. 1 illustrates a configuration of a printing system provided with information processing devices, and a printer or the like connected to the information processing devices, according to an example embodiment of the present invention. The printing system of FIG. 1 includes client PCs (information processing devices) 102 connected to each other via the network 101, a DFE (digital front end) controller 103, and a printer 104 connected to the DFE controller 103. A user uses one of the client PCs 102 to give printing instructions to the DFE controller 103 and the printer 104. The DFE controller 103 is described later with reference to FIG. 8.

When a printing instruction is given from the client PC 102, the job data (the entire printing target is referred to as a job, and the printing data for the job is referred to as job data) and the print settings are sent from the client PC 102 to the DFE controller 103 through the network 101. The DFE controller 103 converts the job data into data that can be used for printing by the printer 104, according to the received job data and the print settings, and sends the converted data to the connected printer 104. Upon receiving the data, the printer 104 performs printing (output operation).

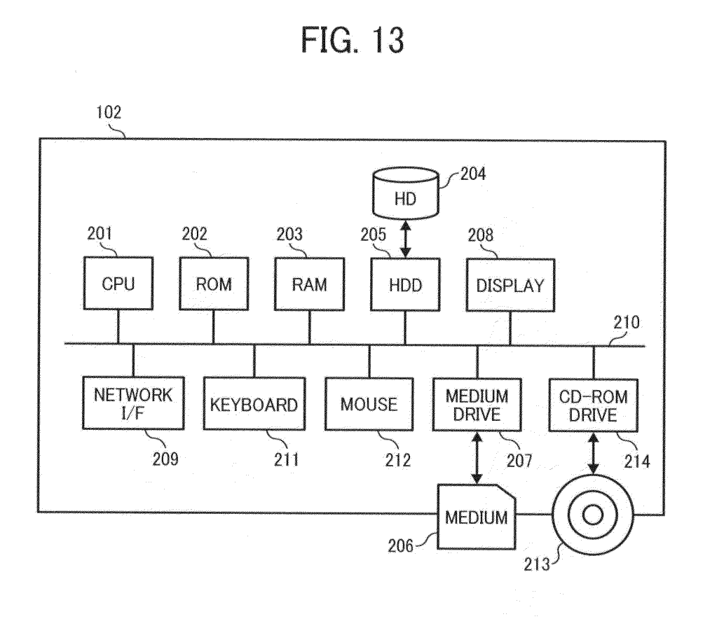

FIG. 13 is a hardware block diagram illustrating a structure of the client PC 102. The client PC 102 includes a CPU 201, a ROM 202, a RAM 203, a HD 204, a hard disk drive (HDD) 205, a medium drive 207, a display 208, a network interface (I/F) 209, a keyboard 211, a mouse 212, and a CD-ROM drive 214, which are electrically connected through a bus 210 such as an address bus or a data bus. The CPU 201 controls entire operation of the client PC 102. The ROM 202 stores a control program for execution by the CPU 201, such as the initial program loader (IPL). The RAM 203 functions as a work area of the CPU 201. The HD 204 stores therein various data. The HDD 205 controls reading or writing of various data with respect to the HD 204 under control of the CPU 201. The medium drive 207 controls reading or writing of various data with respect to a removable recording medium 206 such as a flash memory. The display 208 displays various data such as a cursor, menu, window, character, or image. The network I/F 209 allows the client PC 102 to transmit data through a communication network. The keyboard 211 includes a plurality of keys, each of which is used for inputting a user instruction through a character, a numeral, or a symbol. The mouse 212 allows the user to input a user instruction including, for example, selection or execution of a specific instruction, selection of an area to be processed, and instruction of cursor movement. The CD-ROM drive 214 controls reading or writing of various data with respect to a CD-ROM 213. In alternative to the CD-ROM 213, any removable recording medium may be used.

FIG. 2 illustrates an example of printed materials including insertion pages and exceptional pages, which are produced by the printing system of FIG. 1. For purposes of illustration, it is assumed that the total number of pages of the printed materials depicted in FIG. 2 is 20. Among these 20 pages, print settings common to all printing are applied to pages 1 to 5. In such common print settings, single-sided printing is to be performed on A4 paper without stapling. Before page 6, A5 paper is inserted, and monochrome duplex printing is applied to pages 6 to 7. Pages 8 to 10 are stapled together with two staples on the left. The print settings common to all printing are applied to pages 11 to 20 in a similar manner to pages 1 to 5.

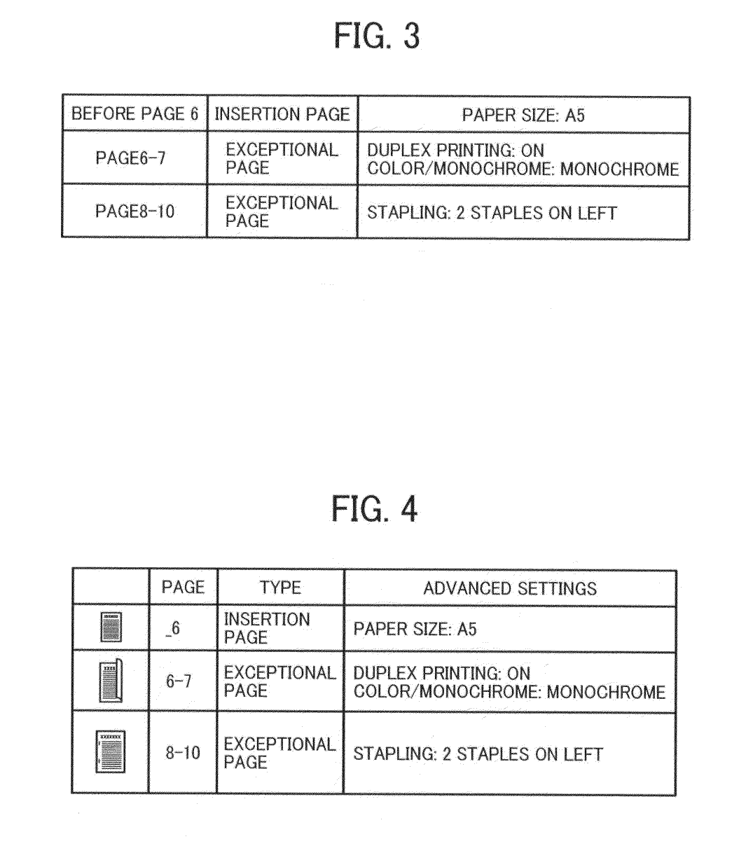

FIG. 3 depicts the details of print settings for special pages, which are used for generating the printed materials of FIG. 2. In the details of the print settings for special pages depicted in FIG. 3, the first row shows that an insertion page of A5 paper exists before page 6. The second row shows that print settings for exceptional pages are applied to pages 6 and 7, and that monochrome duplex printing is to be performed. The third row shows that print settings for exceptional pages are applied to pages 8 to 10, and that these pages are stapled together with two staples on the left. A4 size paper is used for all the other pages, where color single-sided printing is performed without stapling. Printing methods such as duplex printing, single-sided printing, monochrome printing, and color printing, a page layout such as double-page layout where two pages are printed on one page, and the direction of printing are collectively referred to as print mode.

The term “EXCEPTIONAL PAGE” in FIG. 3 refers to a page where the print settings are changed from job settings for normal pages. The term “INSERTION PAGE” in FIG. 3 refers to a page that is inserted at a certain position in the job. FIG. 4 depicts a display screen of a print setting list (excluding job settings) and preview images that correspond to the print setting list, according to an example embodiment of the present invention. In other words, preview images of special page settings that show the finished quality of printing of special pages are shown as icons with a list of special page settings.

Each row of the list of special page settings shows the settings for a special page. In FIG. 4, three sets of special pages are set. The columns of the list show preview images of special page settings, the page numbers of special pages, the types of special pages, and the advanced settings for special pages, respectively. When pages are exceptional pages, the column for page numbers shows the page number (or range of pages). When pages are insertion pages, the column for page numbers shows the position at which those pages are inserted. In other words, “8-10” of exceptional pages shows that pages 8 to 10 are exceptional pages. In regard to the position of an insertion page, “before page 6” is shown as “_{—}6” in FIG. 4 as an example. Alternatively, the position of an insertion page may be shown in a different way. In the column for the type of special page, matters such as insertion page, exceptional page, front cover, and back cover are specified. The print settings common to all printing are shown as job settings. In the column for advanced settings, the details of the settings applied to a relevant special page are specified. In FIG. 4, only those settings that are different from the job settings are listed with the format of “set item=value” as an example. Both the job settings and the special page settings may be shown together in the column for advanced settings.

In the column for preview images, preview images of special page settings are displayed. Due to these preview images, the advanced settings for special pages can be visually confirmed. For example, the preview image of special page settings of pages 6 to 7 in FIG. 4 shows “DUPLEX PRINTING: ON” by a rolled-up page on the right. The preview image of special page settings of pages 6 to 7 in FIG. 4 shows “COLOR/MONOCHROME=MONOCHROME” by showing a monochrome preview image. Moreover, the advanced settings of the exceptional pages 8 to 10 of FIG. 4 show “STAPLING: 2 STAPLES ON LEFT”. On the preview image of special page settings, two staples are shown on the left. When the advanced settings show “STAPLING: 2 STAPLES ON TOP”, two staples are shown on the top of the preview image. Note that finishing operations such as stapling, sorting, punching, and folding are collectively referred to as post-processing. As described with reference to FIG. 4, it is easy to check the final product of special page settings according to the present example embodiment because preview images are displayed in a column to correspond to the special page settings.

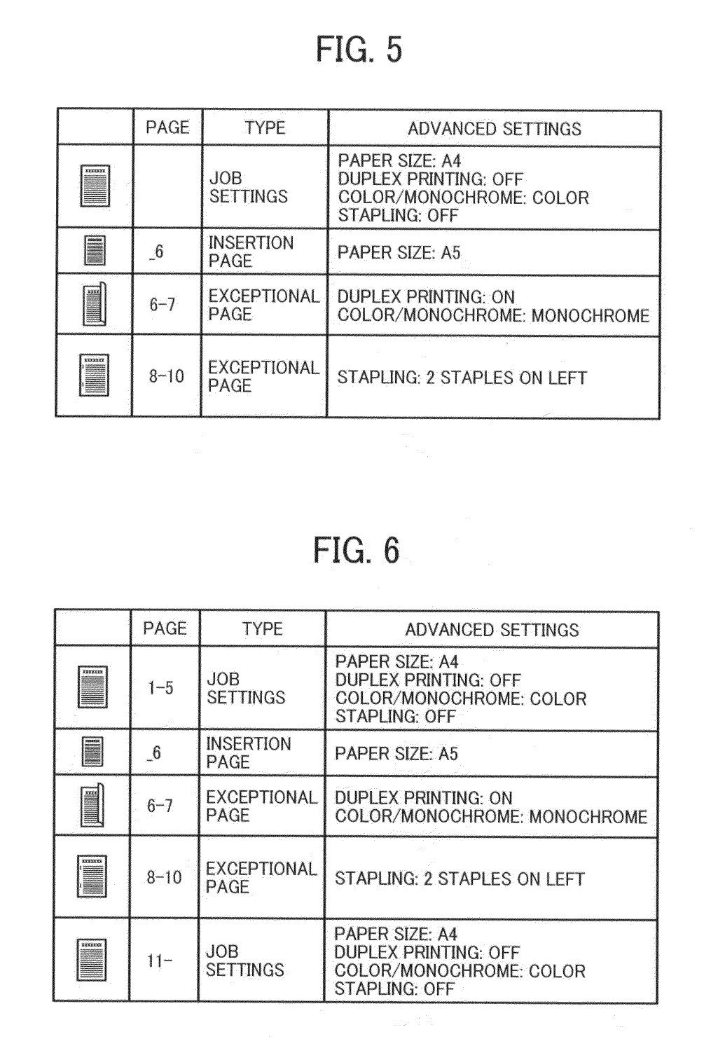

FIG. 5 depicts a display screen of a print setting list (including job settings) and preview images that correspond to the print setting list, according to an example embodiment of the present invention. In FIG. 5, a list of job settings and the preview image of job settings that shows the finished quality are depicted in addition to the special page settings of FIG. 4. In the print setting list of FIG. 5, pages or a range of pages based on job settings are divided into two or more sections because printing materials include an insertion page and exceptional pages. The job settings are collectively shown in the first row of the list. As described above, job settings and the preview image of job settings are displayed together, and thus the image of the final product including special pages can instantly be checked.

FIG. 6 depicts a display screen of another print setting list (including job settings) and preview images that correspond to the print setting list, according to an example embodiment of the present invention. In FIG. 6, the job settings and the preview images of job settings are shown at two places such that pages are in an ascending numeric order from the top to bottom of the list. For example, when the special page settings of FIG. 3 are to be applied, the special page settings are to be applied to pages 6 to 10, and the special page settings are not applied to (or the job settings are applied to) pages 1 to 5 and pages 11 to 20. In this case, the job settings for pages 1 to 5, the special page settings, and the job settings for pages 11 to 20 are shown in the first row, the second to fourth rows, and the fifth row of the list, respectively.

In other words, the job settings and the special page settings are shown such that pages are in ascending numeric order from the top to bottom of the list. By so doing, the image of the finished quality of printing materials can instantly be checked from the top page to the bottom page. In FIG. 6, the list of job settings and special page settings, and their preview images are shown such that pages are in an ascending numeric order from the top to bottom of the list, but they may be shown in descending order. In both ways, the overall image of the finished quality of printing materials can instantly be checked. In the description above, the preview images of special page settings are shown on the left of a displayed list. However, the display layout is not limited to this layout, but is variable as long as the preview images can be viewed in association with the list of special page settings.

Next, a description is given of how preview images of special page settings and preview images of job settings are generated and displayed by the client PC 102 and the DFE controller 103.

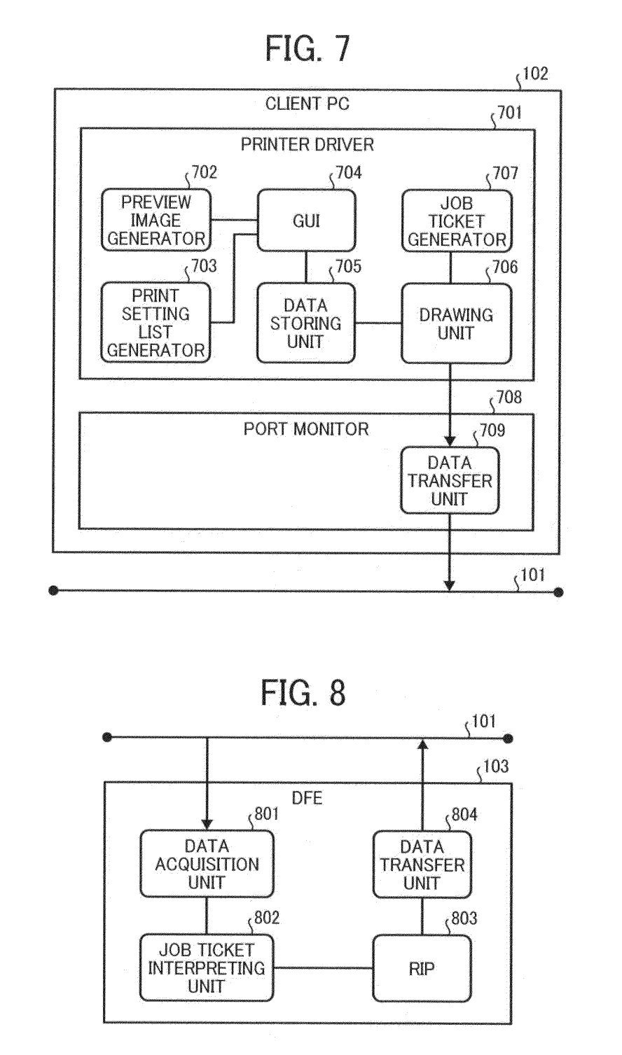

FIG. 7 is a functional block diagram of the client PC 102. The client PC 102 includes a printer driver 701 and a port monitor (i.e., a type of device driver for transmitting printing data) 708, as illustrated in FIG. 7. The printer driver 701 includes a preview image generator 702, a print setting list generator 703 that generates a print setting list including the print settings for special pages, a GUI (graphical user interface) 704, a data storing unit 705, a drawing unit 706, and a job ticket generator 707. The port monitor 708 includes a data transfer unit 709.

The preview image generator 702 is connected to the GUI 704, and the GUI 704 is connected to the print setting list generator 703 and the data storing unit 705. The drawing unit 706 is connected to the data storing unit 705, the job ticket generator 707, and the data transfer unit 709 of the port monitor 708. The GUI 704 serves as a print setting accepting unit that accepts instructions for print settings including the print settings for special pages, and as a print setting display unit that displays on a display unit such as an LED (light-emitting diode) a preview image based on a print setting list and print settings.

In the printer driver 701 of the client PC 102, the GUI 704 generates a window on the screen of the client PC 102 for accepting instructions for print settings. The preview image generator 702 generates preview images of special page settings and preview images of job settings based on the print settings, and displays these images on the GUI 704. The data storing unit 705 stores the job settings and the special page settings in a memory of the client PC 102 such as the HDD 205.

The drawing unit 706 generates PDL (page description language) data according to the job data. In other words, the drawing unit 706 describes the printing data in page description language, thereby converting the printing data into data that serves as printing instructions to be given to the printer 10. The job ticket generator 707 generates a job ticket according to the job settings and the special page settings. The data transfer unit 709 of the port monitor 708 transfers the job ticket and PDL data to the DFE controller 103 through the network 101. Note that the elements of the client PC 102 described above are functions implemented as programs.

FIG. 8 is a block diagram illustrating the functions of the DFE controller 103 according to an example embodiment of the present invention. The DFE controller 103 receives printing data from the client PC 102 and converts the received printing data into data used to perform printing at the printer 104. As illustrated in FIG. 8, the DFE controller 103 includes a data acquisition unit 801, a job ticket interpreting unit 802, an RIP (raster image processor) 803, and a data transfer unit 804.

The data acquisition unit 801 acquires the PDL data and job tickets sent from the client PC 102. The job ticket interpreting unit 802 acquires print settings by interpreting what is described in the job ticket acquired by the data acquisition unit 801. The RIP 803 performs raster image processing according to the PDL data and the print settings acquired from the job ticket interpreting unit 802, and generates bit map data. Note that the raster image processing refers to processing in which job data described in page description language is converted into printable bit map data. The data transfer unit 804 transfers the generated bit map data to the printer 104 through the network 101.

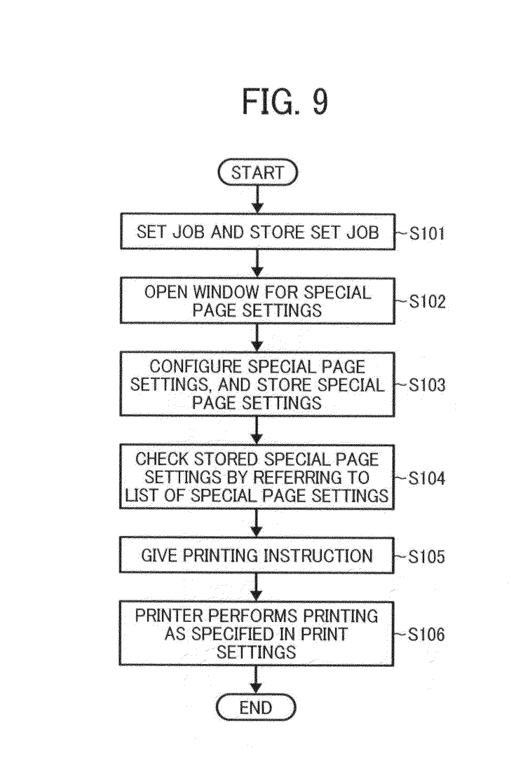

FIG. 9 is a flowchart of an operating procedure for configuring special page settings and performing printing, according to an example embodiment of the present invention. Firstly, a user sets a job on the screen of the client PC 102, which is displayed by the printer driver 701, by using an input device such as a mouse, and stores the set job in a memory of the client PC 102 such as the HDD 205 (S101). Next, the user opens a window for making special page settings (S102). Next, the user configures special page settings on the opened window for making special page settings, and then stores the special page settings in a memory of the client PC 102 such as the HDD 205 (S103). The user displays the list of the special page settings to check the stored special page settings (S104). Due to this checking operation, the user can review the advanced settings for special pages as necessary. Next, the user gives printing instructions to the printer 104 as specified in the set job and the special page settings (S105). The printer 104 performs printing as specified in the print settings (S106).

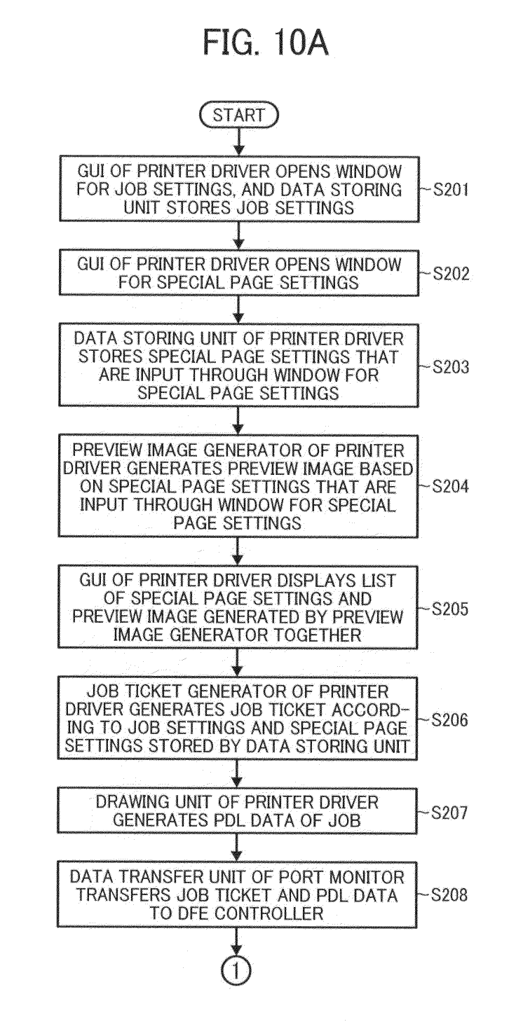

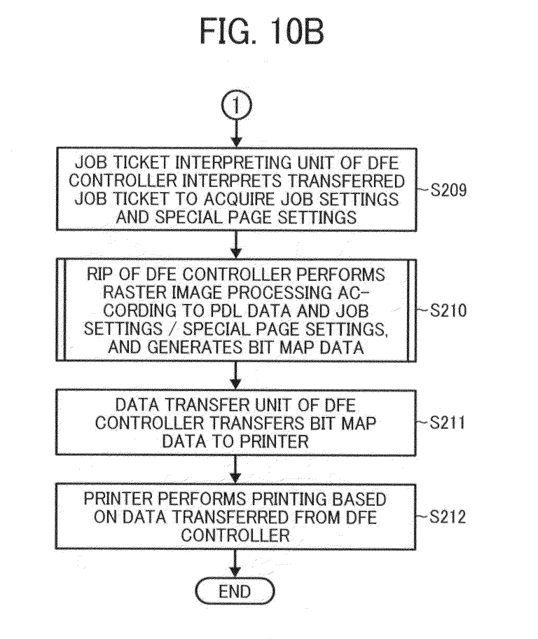

FIGS. 10A and 10B are flowcharts of the processes performed by the client PC 102 and the DFE controller 103, which correspond to the operating procedure depicted in FIG. 9.

When a user instructs the printer driver 701 to display a window for making print settings for a job, the GUI 704 of the printer driver 701 displays a window on a PC screen for making job settings. When the user has made print settings for a job, the data storing unit 705 of the printer driver 701 stores the print settings in a memory of the client PC 102 such as the HDD 205 (S201). Next, when the user opens a window for making the special page settings, the GUI 704 of the printer driver 701 opens the window for making special page settings (S202). When the user has made and stored the special page settings, the data storing unit 705 of the printer driver 701 stores the special page settings in a memory of the client PC 102 such as the HDD 205 (S203).

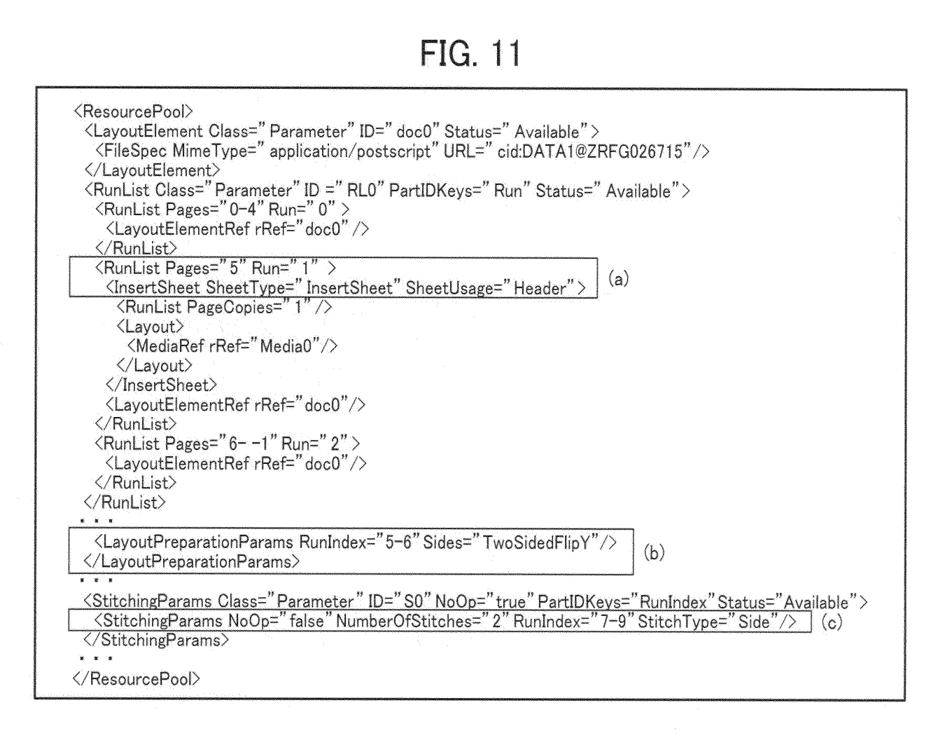

Next, the preview image generator 702 of the printer driver 701 generates preview images of special page settings based on the special page settings stored in step S203 (S204). When it is desired that print setting lists as illustrated in FIGS. 5 and 6 be displayed, the preview image generator 702 generates preview images of job settings. The GUI 704 of the printer driver 701 displays a list of the special page settings stored in step S203 and preview images of the special page settings together such that the list and the preview images are next to each other (S205). In a similar manner to step S204, when it is desired that print setting lists as illustrated in FIGS. 5 and 6 be displayed, the GUI 704 of the printer driver 701 displays a list of the job settings and preview images of the job settings together such that the list and the preview images are next to each other. Then, a printing instruction is given by the user (step S105 in FIG. 9), and the job ticket generator 707 of the printer driver 701 generates a job ticket according to the job settings and special page settings stored by the data storing unit 705 (S206). For example, when the special page settings illustrated in FIG. 3 are input, a job ticket depicted in FIG. 11 is generated. A job ticket is described later in detail.

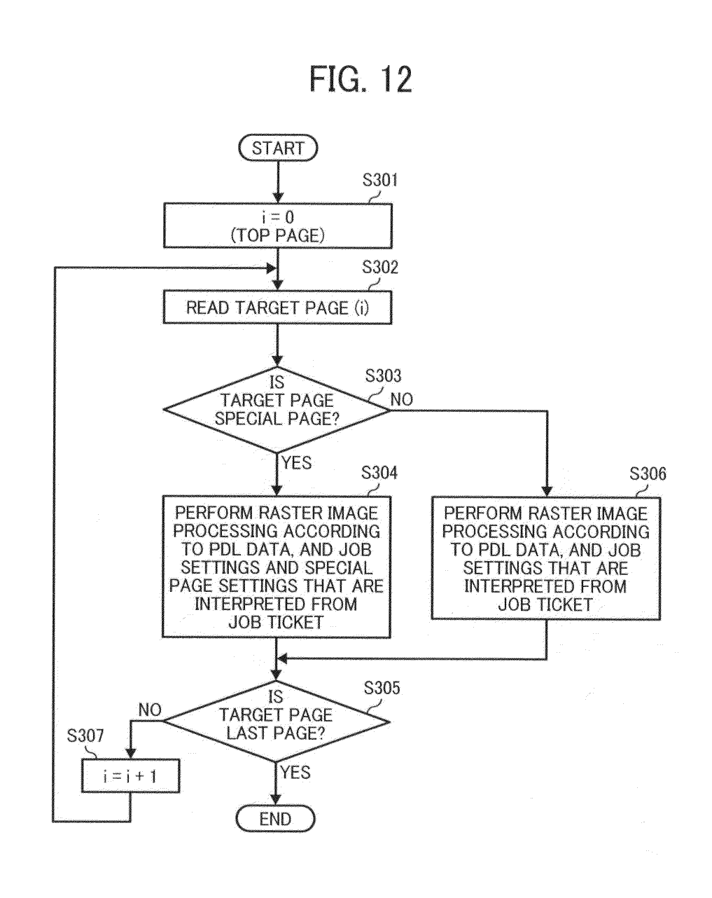

Next, the drawing unit 706 of the printer driver 701 generates PDL data (S207). Note that it is not necessary to consider special page settings in the PDL data, only the job settings. In other words, because the special page settings are specified in the job ticket generated in step S206, even when, for example, the special page settings depicted in FIG. 3 are introduced, the PDL data generated herein should be based only on the job settings of pages 1 to 20. Special pages are identified in the raster image processing of FIG. 12 as described later, and the PDL data of the special pages are generated therein.

Next, the data transfer unit 709 of the port monitor 708 transfers the job ticket and PDL data that are generated in steps S206 and S207, respectively, to the DFE controller 103 (S208). The job ticket interpreting unit 802 of the DFE controller 103 interprets the job ticket transferred in step S208 to acquire the job settings and special page settings configured by the user (S209). For example, when the job ticket depicted in FIG. 11 is transmitted, what is described therein is interpreted that the insertion page (before page 6) is configured from portion (a) of FIG. 11, the exceptional pages (pages 6 to 7) are configured from portion (b) of FIG. 11, and that “DUPLEX PRINTING=ON”. Moreover, it is interpreted that the exceptional pages (pages 8 to 10) are configured from portion (c) of FIG. 11, and that these pages are stapled together with two staples on the left.

By so doing, the DFE controller 103 can acquire the job settings and special page settings that are introduced on the printer driver 701 side. Then, the RIP 803 of the DFE controller 103 performs raster image processing according to the PDL data transferred from the data transfer unit 709 of the client PC 102 in step S208 and the print settings acquired in step S209, and generates bit map data (S210).

The generated bit map data is transferred to the printer 104 by the data transfer unit 804 of the DFE controller 103 (S211). The printer 104 performs printing based on the data transferred from the DFE controller 103 (S212), and terminates the process.

FIG. 11 depicts an example (extract) of a job ticket according to an example embodiment of the present invention. Portion (a) of FIG. 11 shows the special page settings of an insertion page to be inserted before page 6. Note that the page number of a job ticket starts from “0”, and thus “5” at “RunListPages” of portion (a) in FIG. 11 shows page 6. Portion (b) of FIG. 11 shows that pages 6 to 7 are exceptional pages. “DUPLEX PRINTING=ON” shown in the advanced settings for special pages shows that duplex printing is to be performed. “Sides=“TwoSidedFlipY”” is an expression related to duplex printing. Portion (c) of FIG. 11 shows that pages 8 to 10 are exceptional pages, and that these pages are stapled together with two staples on the left. “NumberOfStitches=“2”” and “StitchType=“Side”” show that pages are stapled together with two staples on the left.

The raster image processing of the RIP 803 of the DFE controller 103 are described with reference to FIG. 12.

FIG. 12 is a flowchart of raster image processing where the special page settings are introduced as in FIG. 3. These processes are subroutines of step S210 depicted in FIG. 10B. Firstly, the RIP 803 searches for a target page from the top page in turn (S301), and reads the searched target page (S302). Next, whether or not the target page is a special page is determined (S303). For example, in the case of the special page settings of FIG. 3, pages 1 to 5 are normal pages (not special page) (NO in S303), and thus raster image processing is performed according to the job settings interpreted from a job ticket in step S209 of FIG. 10B and the PDL data of pages 1 to 5 transferred in step S208 of FIG. 10A, to generate bit map data (S306).

By contrast, pages 6 and 7 are determined to be special pages according to the job ticket interpreted in step S209 of FIG. 10B (YES in S303). In that case, raster image processing is performed according to the job settings and the special page settings for pages 6 and 7 that are interpreted from a job ticket in step S209 of FIG. 10B, and the PDL data of pages 6 and 7 transferred in step S208 of FIG. 10A, to generate bit map data (S304).

Next, whether or not a target page is the last page (S305) is determined, and when the target page is not the last page (NO in S305), the page is updated (S307) and the processes of steps S302 to S306 are repeated. When it is determined in step S305 that a target page is the last page (YES in S305), the flow of processes depicted in FIG. 12 terminates. As described above, the overall finished quality of printing and the special page settings can be checked visually by displaying them together, according to at least one embodiment of the present invention. Accordingly, the special page settings can be checked easily. Moreover, it becomes easy to perform printing where special page settings are added to normal page settings.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. An information processing device comprising:
a print setting accepting unit to accept instructions for print settings that include special page print settings;
a print setting list generator to generate a print setting list including the special page print settings;
a preview image generator to generate a preview image that reflects finished quality of printing based on the print settings; and
a print setting display unit to display the preview image on a display based on the print setting list and the print settings.

2. The information processing device according to claim 1, wherein the print setting display unit displays the preview image in association with the print settings in the print setting list.

3. The information processing device according to claim 1, wherein when pages excluding a special page are divided into a plurality of pages or a plurality of sets of pages, the print setting display unit displays the plurality of pages or the plurality of sets of pages separately.

4. The information processing device according to claim 1, wherein the print setting display unit displays the print setting list in ascending or descending numeric order of the pages.

5. The information processing device according to claim 1, wherein the print setting display unit displays the print setting list of the special pages in ascending or descending numeric order of the pages, and displays the print settings excluding the special page print settings collectively.

6. The information processing device according to claim 1, wherein the preview image that reflects finished quality based on the print settings includes information indicating a recording medium size.

7. The information processing device according to claim 1, wherein the preview image that reflects finished quality based on the print settings includes information indicating a print mode.

8. The information processing device according to claim 1, wherein the preview image that reflects finished quality based on the print settings includes information indicating post-processing to be applied.

9. A method of displaying print settings, the method comprising:
accepting print settings including special page print settings;
generating a print setting list including the special page print settings;
generating a preview image showing finished quality of printing based on the print settings; and
displaying the preview image on a display based on the print setting list and the print settings.

10. A computer-readable non-transitory recording medium storing a program for causing an information processing device to execute a method of displaying print settings, the method comprising:
accepting print settings including special page print settings;
generating a print setting list including the special page print settings;
generating a preview image showing finished quality of printing based on the print settings; and
displaying the preview image on a display based on the print setting list and the print settings.
